(19) United States
(12) Patent Application Publication
(10) Pub. No.: US 2006/0175491 A1
(43) Pub. Date: Aug. 10, 2006

(54) Tissue packet holder

(76) Inventor: Mary K. Hays, Allison Park, PA (US)

Correspondence Address: William L. Krayer, 1771 Helen Drive, Pittsburgh, PA, 15216, US

(21) Appl. No.: 11/358,005

(22) Filed: Feb. 21, 2006

Related U.S. Application Data
(63) Continuation-in-part of application No. 10/190,039, filed on Jul. 5, 2002, now abandoned.

(51) Int. Cl. G09F 7/18

(52) U.S. Cl. 248/229.16

(57) ABSTRACT

A bracket is designed to hold a small collapsible packet of tissues on an automobile visor, permitting ready access to individual tissues. The bracket has a generally S-shaped profile, forming clamps for the visor and the tissue packet. The clamping portions have sufficient clamping effect to assure the bracket is held on the visor even if the visor is turned down, and to assure the tissue packet is retained even if there is only one tissue left. In another version, the bracket is a U-clamp having an adhesive area on one side, suitable for adhering a packet of tissues to it. The packet of tissues is desirably also equipped with an adhesive area. When the packet is empty, it is removed and another packet conveniently replaces it.

### RELATED APPLICATION

This application is a continuation-in-part of my copending patent application Ser. No. 10/190,039 filed Jul. 5, 2002 and claims the full benefit of 35 USC 120 therefor.

### TECHNICAL FIELD

A holder for a small collapsible packet of tissues is adapted to clamp to an automobile visor. Tissues may be removed from the packet without removing it from the holder and the packet remains firmly held until the tissues are depleted.

### BACKGROUND OF THE INVENTION

Automobile drivers and their guests have occasional need of tissues, but it can be distracting and unsafe to grope for them in a glove compartment or other compartment in the automobile. A holder for tissues within easy reach would be desirable from the standpoints of convenience and safety.

The holder should preferably be readily attached and filled with tissues. A bracket disclosed by Gross in U.S. Pat. No. 5,065,970 is designed to accommodate an entire box of tissues of the more or less standard size. While the bracket is designed to be fixed to an automobile visor, the rigidity of the box is utilized to help retain it in the bracket. That is, when the tissue box is inserted in the space between the bottom ledge of the bracket and the visor, the box fills the space between the bottom ledge and the visor, regardless of how full or empty the box. The Gross design is not useful for a small collapsible packet of tissues.

For those who do not desire or require an entire box of tissues, it would be convenient and less obtrusive to have a holder for a small packet of tissues. Such small packets have become more or less standard in dimensions, being generally rectangular—about 2 and ¼ inches by about 4½ inches, and one-half inch to an inch thick. However, these common packets have no rigid sides. Not having the rigid construction of a box, they would collapse within a rigid container such as proposed by Gross for a full box of tissues, even if the Gross box were sized appropriately.

### SUMMARY OF THE INVENTION

My invention is designed specifically to accommodate a small collapsible packet of tissues of the more or less standard size mentioned above, i.e. about 2 and one quarter inches wide by about 4 and one-half inches long by about ¾ inches thick. My invention should not be considered limited to such specific dimensions, however; it is directed to a collapsible container of tissues such as are marketed in and held by a thin normally transparent wrap. Such packets of tissues typically are designed with a tab or other opening to permit sequential dispensing of the tissues.

My invention comprises a resilient S-profile bracket of material and dimensions capable of clamping to the visor and also to the packet of tissues. The lower ledge of the bracket—that is, the ledge designed to hold the tissues—should have an open area near its center to facilitate removal of tissues one at a time, preferably through the opening normally found in such a packet. The material of construction should be resilient so that it will return to the original shape after it is bent to clamp to the visor and the tissue pack.

Thus, my invention may be said to include a visor bracket for a packet of tissues comprising an upper support, a central ledge, and a lower ledge, a first connecting member connecting the upper support from an edge thereof to the central ledge at a first edge of the central ledge, a second connecting member connecting the lower ledge from an edge thereof to a second edge of the central ledge, the second edge of the central ledge being opposite the first edge thereof, the upper support, first connecting member, central ledge, second connecting member, and lower ledge thereby forming a bracket having an S-shaped profile, the bracket further being resilient so as to be capable of clamping onto an automobile visor between the upper support and the central ledge and retaining a collapsible packet of tissues between the central ledge and the lower ledge.

My invention also includes a bracket for dispensing tissues from under an automobile visor comprising an upper resilient clamp for attaching said bracket to said visor and a lower resilient clamp connected thereto for clamping a collapsible tissue packet, said lower resilient clamp being capable of retaining said collapsible tissue packet throughout its tenure of use while permitting tissues to be removed from said packet without moving said packet out of said bracket, the bracket including a collapsible packet of tissues held in the lower resilient clamp.

My invention also includes a tissue holder and dispenser for clamping onto an automobile visor, comprising a U-shaped clamp having internal and external surfaces, at least one of the external surfaces including a surface adhesive area, and a packet of tissues adhering to the external surface adhesive area. The packet of tissues in this case need not be a collapsible packet, although a collapsible packet is quite useful. The collapsible packet of tissues is typically, as indicated above, about 2 and ¼ inches by about 4½ inches, and one-half inch to an inch thick, but may conveniently be from 1 and ½ inches to about 3 inches wide, about three and ½ to about six inches long, and about ½ inch to about one and 2 inches thick. Such a thickness will accommodate about ten to about twenty five interleaved 2-ply tissues having the dimensions 8.6 inches by 8.3 inches. I do not intend to be limited to this size of tissue, however; the tissues may be from about six inches by six inches square to about eleven inches by eleven inches square, and rectangular shapes having sides within the range six to eleven inches. Thus the areas of the tissues may range from about 36 square inches to about 121 square inches. Areas smaller than 36 square inches are impractical for use as a facial tissue; areas greater than 121 square inches are too large for convenient dispensing from an automobile visor. As is known in the art, the tissues are commonly interleaved or “z-folded” (see U.S. Pat. No. 5,524,759 to Herzberg) to facilitate removal, as the removal of a tissue through the intended opening will expose the next tissue in the series to easy removal. “Z-folding” or other interleaved or layered packaging is necessary, in addition to facilitating convenient removal, to reduce the area (as opposed to the thickness) of the packet to an area to within the range specified above—that is to an area defined by sides 1.5 to 3 inches by 3.5 to 6 inches. The tissues will typically be enclosed in a thin, flexible plastic film having a flap including an adhesive strip or other shape which can be easily lifted to expose the first tissue. The Herzberg U.S. Pat. No. 5,524,759 is hereby incorporated herein by reference in its entirety. In particular, I may use any of the tissue packets described in the Herzberg '759 patent by attaching to the side opposite the flap an adhesive strip. I call this side the back. However, the packet need not be collapsible; the adhesive strip may be attached to the back of a similarly shaped and sized cardboard, metal or stiff plastic container, so that it may be adhered to the adhesive on the U-clamp. The U-clamp itself may be made of any material capable of clamping onto an automobile visor in the shape shown. Such materials include various synthetic plastics and metals. When I use the term “tissue packet” or “packet of tissues” herein, I mean a plurality of tissues suitably packaged within the dimensions described above that is, defined by sides 1.5 to 3 inches by 3.5 to 6 inches, a thickness of 0.5 to 1.5 inches, the tissues being no smaller than 36 square inches in area.

### BRIEF DESCRIPTION OF THE DRAWINGS

FIG. 1a is a perspective view of my preferred tissue visor bracket, without a tissue packet.

FIG. 1b shows the bracket of FIG. 1a installed on an automobile visor and filled with a tissue packet.

FIGS. 2a and 2b show an alternate design made of wire.

FIG. 3 is a further alternate bracket design.

FIG. 4 is an underside view of another alternate lower ledge.

FIGS. 5 and 6 are also underside views of other lower ledge designs within my invention.

FIG. 7 shows the U-clamp prior to placing the tissue packet on it.

FIG. 8a is a packet of tissue useful in my invention. FIG. 8b shows the back of the packet.

FIG. 9 shows the invention comprising the U-clamp and an adherent flexible tissue packet on it, installed on an automobile visor.

FIG. 10 is the invention comprising the U-clamp and an adherent stiff tissue packet adhered to it.

### DETAILED DESCRIPTION OF THE INVENTION

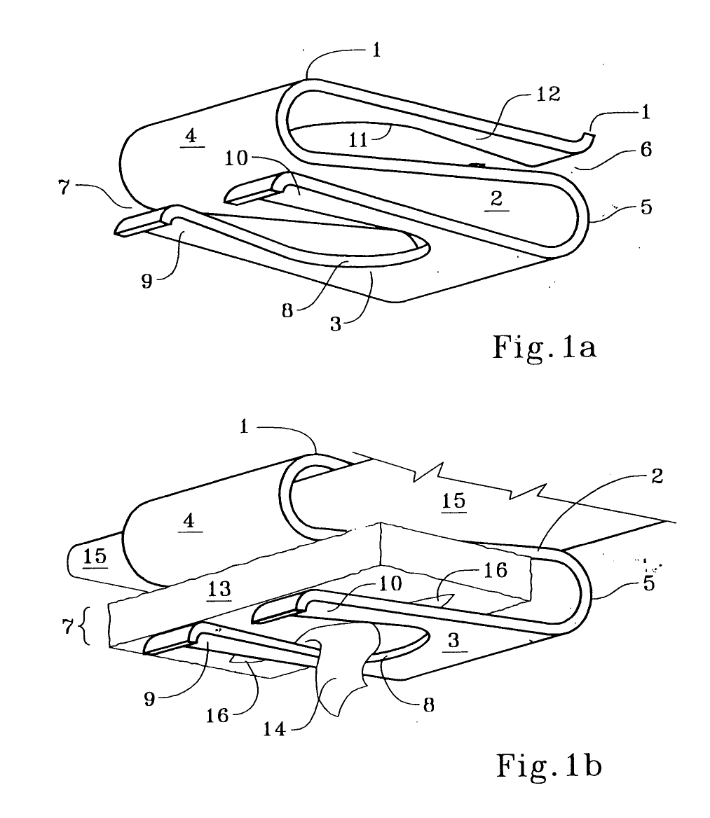

Referring now to FIG. 1a, my preferred bracket is made of a sheet of thermoplastic material which has been formed into the substantially S-shaped profile shown, having an upper support 1, a central ledge 2, and a lower ledge 3. The preferred unitary device has a connecting member 4 connecting the edges of upper support 1 and central ledge 2, and a connecting member 5 connecting an edge of lower ledge 3 and central ledge 2. The connecting members 4 and 5 integrate with central ledge 2 at opposite ends of central ledge 2, thus forming the generally S-shaped profile shown. While upper support 1 and central ledge 2 may be substantially parallel, it is preferred that they converge from the separation effected by connecting member 4 to a constricted opening 6. Connecting member 4 should be wide enough to accommodate the width of a typical automobile visor, i.e. about one-half inch, and should have a degree of resiliency sufficient to assure a clamping effect on a visor placed between upper support 1 and central ledge 2. Lower ledge 3 converges from the width of its connecting member 5 to a constricted opening 7 near connecting member 4, at the end of central ledge 2. While the end of lower ledge 3 need not necessarily directly contact central ledge 2, it should be close enough, if it does not contact, that even a tissue packet with one tissue left in it will be retained in the space between lower ledge 3 and the underside of central ledge 2.

Lower ledge 3 is designed in this configuration to have a U-shaped opening 8 for tissues to be removed directly from the tissue packet secured between lower ledge 3 and central ledge 2, as will be further discussed in FIG. 1b. The U-shaped opening 8 is formed by two prongs, 9 and 10. For ease of manufacture and possibly economy of material, a similar U-shaped opening 11 may be made in upper support 1, shown in FIG. 1a as having prong 12. While opening 8 is useful for the ready removal of tissues from a packet held between lower ledge 3 and central ledge 2, opening 11, and the prongs 12 in support 1 are optional. However, it should be recognized that the configuration of FIG. 1a is symmetrical and reversible—that is, support 1 and lower ledge 3 may be used in reverse roles. For manufacturing, this means the bracket may be fabricated from a sheet of thermoplastic by cutting the two U-shaped openings 8 and 11 from a generally rectangular sheet, heating the areas of incipient connecting members 4 and 5 to form them as shown, and permitting them to cool and stiffen to the shape shown. It will not matter then, how the bracket is oriented on the visor since both support 1 and lower ledge 3 will have an opening 8 suitable for removing tissues from the packet.

In FIG. 1b, the bracket of FIG. 1a is illustrated in place on the visor 15, and it holds a tissue packet 13. A sheet of tissue 14 projects from the packet 13 through packet slit 16 and bracket opening 8, conveniently ready for use by the driver, who need only reach up to extract it. Visor 15 was inserted into constricted opening 6, which now has the opening dimension of the visor 15; likewise, the substantially full tissue packet 13 causes constricted opening 7 to be widened, while the resilient properties of connecting member 5 exerts enough pressure, through lower ledge 3 and prongs 9 and 10, on tissue packet 13 to hold it in place. The resiliency of connecting members 4 and 5 should be sufficient to retain the bracket and the tissue packet in place on the visor even if the visor is turned down. Likewise, connecting member 5 exerts pressure on the tissue packet 13 as its thickness diminishes, particularly until there is as few as one tissue left in the packet. At that point, the lower ledge 3 will be oriented substantially as depicted in FIG. 1a.

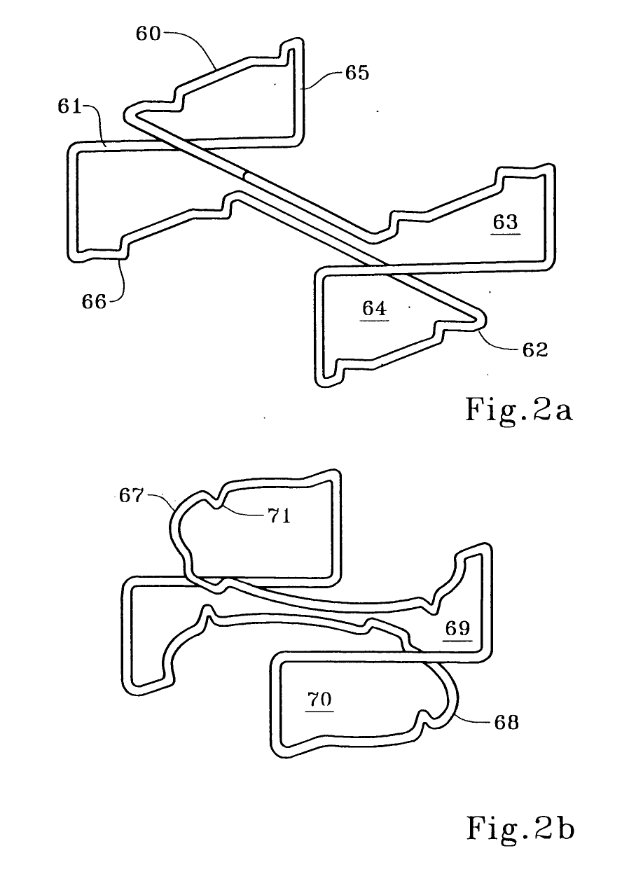

Referring now to FIG. 2a, it is seen that wire may be used to form a shape functionally similar to that of FIGS. 1a and 1b. Here, members 60 and 62 are similar in function to upper support 1 and lower ledge 3 in FIG. 1a, segment 65 is similar to connecting member 4, and the wire frame is formed to provide spaces 63 and 64 for the visor and tissue pack. The edge 62 of the lower ledge converges toward central ledge 61. At 66, it is seen that the wire can be formed into a shape designed to enhance the holding capability of a ledge, by bending it on the plane of the lower ledge. The variation of FIG. 2a is symmetrical. In FIG. 2b, the wire is formed slightly differently, showing nubs 71 which project into the space where the visor and tissue pack will be—that is, the nubs 71 are not on the same plane as the ledges. Spaces 69 and 70 are configured functionally substantially as in FIGS. 1a and 1b. As with the thermoplastic or other material used in the planar design of FIGS. 1a and 1b, the wire should have a resiliency such that it will hold firmly to the visor and also to the tissue pack even with only one tissue left.

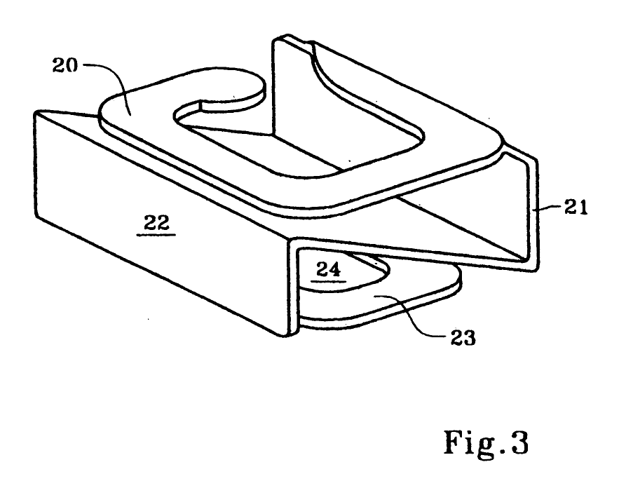

The variation of FIG. 3 shows a substantially hook-shaped upper ledge member 20 and substantially planar connecting members 21 and 22. Lower ledge 23 may also be substantially hook-shaped in order to make the bracket vertically reversible as is the unit of FIGS. 1a and 1b. The hook shaped ledge members 20 and 23 define a central opening 24 big enough to permit the ready extraction of a tissue from a tissue pack while still holding it firmly. Again, the resilience of connecting members 21 and 22 provide a clamping action on the visor and tissue packet respectively; in the case of the tissue packet, connecting member 22 will cause lower ledge member 23 to gradually close on the tissue packet as it is depleted. Unlike FIGS. 1a and 1b, however, this bracket is dimensioned so that the tissue packet will not project from the sides as in FIG. 1b—that is, the overall dimensions of the bracket are such that a standard tissue packet 34 will occupy substantially the same volume as is covered by the bracket.

FIG. 4 shows the face shape of an alternative lower ledge (viewed from the under side). Here, arms 30 and 31 are functionally similar to prongs 9 and 10 of FIG. 1a. The edge 32, as depicted, connects to a connecting member functionally similar to connecting members 5 and 22 of FIGS. 1a and 3. Again, the same design can be used for the upper ledge (mostly obscured here), but need not be, since there is no need for an opening 33 in upper support 1 (FIG. 1a).

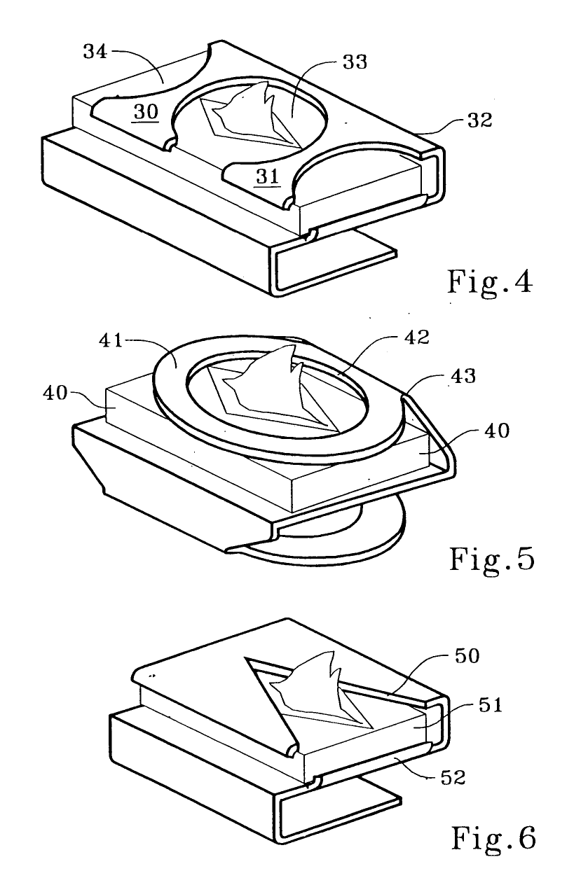

FIG. 5 (also a view from the underside) illustrates that the lower ledge need not have prongs—it is sufficient if there is an opening in the lower ledge permitting the extraction of a tissue from the packet 40. Thus, here, the lower ledge 41 is oval-shaped with an oval opening 42. As with edge 32 of FIG. 4, edge 43 is connected to a connecting member functionally similar to connecting members 5 and 22 of FIGS. 1a and 3, so the tissue packet 40 is continuously held in place.

FIG. 6 shows yet another design for the underside lower ledge. Here, the opening 50 for the tissues is angular and three of the outer edges of the ledge form a substantially rectangular shape to accommodate a contiguous tissue packet 51. The design is similar in function to the open-ended hook shape of FIG. 3. An optional flange 52 may be used to assure retention of the tissue packet 51 in its place.

The materials used in my invention are important only in that the construction should provide the clamping effects described above for the visor and the tissue packet. Useful materials include both thermoplastic and thermosetting synthetics, either of which may be filled with various common fillers or fiber reinforcements. They may be formed and/or fabricated from sheet material or molded, i.e. compression molded or injection molded. In the case of wire, again, it should be capable of returning to an original shape after providing the necessary clamping effects. Wire designs can emulate the shapes of the drawings herein. Sheet metal can also be used, provided it will clamp the tissue packet and retain its position on the visor in ordinary usage.

Thus my invention includes a visor bracket for a packet of tissues comprising an upper support, a central ledge, and a lower ledge, a first connecting member connecting the upper support from an edge thereof to the central ledge at a first edge of the central ledge, a second connecting member connecting the lower ledge from an edge thereof to a second edge of the central ledge, the second edge of the central ledge being opposite the first edge thereof, the upper support, first connecting member, central ledge, second connecting member, and lower ledge thereby forming a bracket having an S-shaped profile, the bracket further being resilient so as to be capable of clamping onto an automobile visor between the upper support and the central ledge and retaining a collapsible packet of tissues between the central ledge and the lower ledge, the lower ledge also defining a central opening for tissues to be removed from the collapsible tissue packet. In another aspect, my invention includes a bracket for dispensing tissues from under an automobile visor comprising an upper resilient clamp for attaching the bracket to the visor and a lower resilient clamp connected thereto for clamping a collapsible tissue packet, the lower resilient clamp being capable of retaining the collapsible tissue packet throughout its tenure of use while permitting tissues to be removed from the packet without moving the packet out of the bracket. Also, in another aspect, my invention includes a tissue holder for an automobile comprising a formed sheet of thermoplastic, the sheet having been formed and fabricated to a profile of dimensions providing a visor recess and a tissue packet recess, the visor recess being capable of clamping on an automobile visor and the tissue packet recess being capable of clamping on a collapsible tissue packet in both a full condition and an empty condition, the formed sheet including defining an opening for withdrawing tissues from a tissue packet in the tissue packet holder.

Referring now to FIGS. 7, 8a, 8b, 9, and 10, U-clamp 70 is shown in FIG. 7 without the tissue packet on it. U-clamp 70 need not be shaped exactly as shown, but will comprise two generally parallel sides 71 and 72 which desirably converge somewhat at their termini 73 and 74. The two parallel sides 71 and 72 are connected by resilient connector 75 so that the U-clamp is capable of clamping on an automobile visor. As is generally known, an automobile visor may be of a thickness from one-quarter inch to one and one half inches, and the U-clamp should be designed accordingly—that is, so that it has a dimension within that range between points A and B across the length of connector 75. Prominent on the surface of side 71 in FIG. 7 is an area marked “Adhesive.” This may be double-sided adhesive tape, Velcro, or an adhesive chosen for its ability to retain its adhesive properties after more than one use. The shape of the Adhesive area need not be exactly as shown—it may be circular, square, or, if a strip, it may be oriented ninety degrees from the illustrated strip.

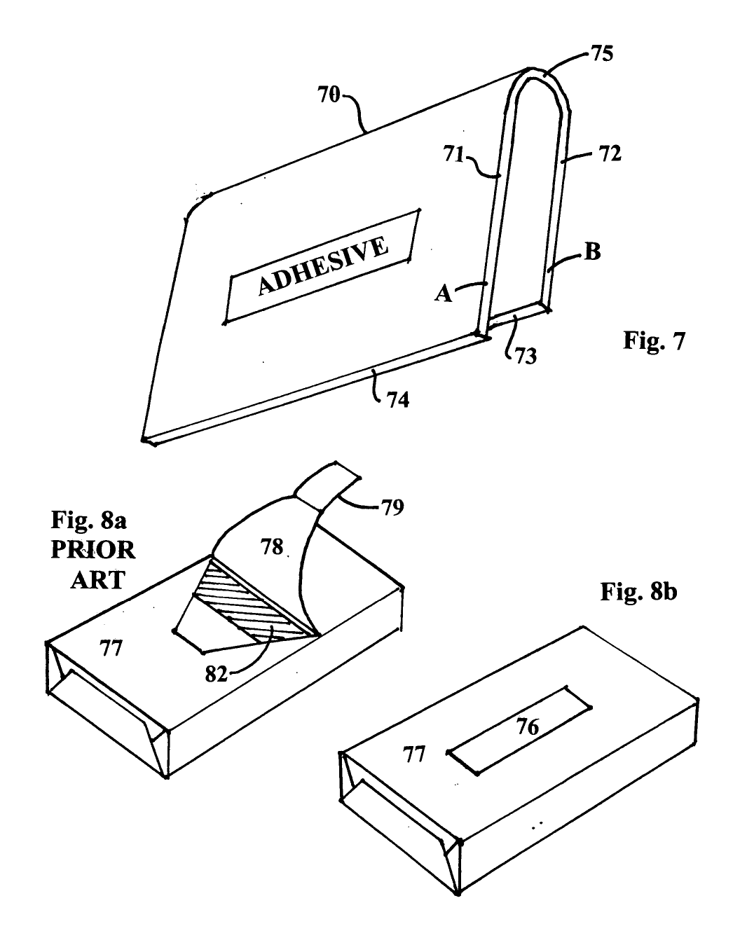

FIG. 8a is adapted from FIG. 6 of Herzberg's U.S. Pat. No. 5,524,759. FIG. 8a shows a flap 78 opening on a thin flexible packet of tissues 77, exposing tissues 82. The flap 78 includes an adhesive closure 79. In FIG. 8b, the back of the packet 77 is seen to be equipped with an adhesive strip 76. Adhesive strip 76 is shown to be about the same size and shape as the adhesive area in FIG. 7. This is desirable, but not essential, so long as there is sufficient contact between the two surface areas to retain the packet throughout its use on the U-clamp and in spite of the tension or force it may experience from removing the tissues. Indeed, the adhesive need not be present on packet 77 if the adhesive on U-clamp 70 is sufficiently strong to hold the packet without it; conversely, the adhesive need not be present on the U-clamp if the adhesive strip 76 on the packet is sufficiently strong to adhere to the U-clamp 70 throughout the packet's tenure of use. The adhesive in both areas should not be so strong as to permanently retain the packet or its enclosure on the U-clamp. Most desirably, the adhesive, whether on just one or both surfaces, should be strong enough to retain the packet throughout its tenure of use on the U-clamp but weak enough to enable the user to remove the packet enclosure without undue effort and replace it on the U-clamp.

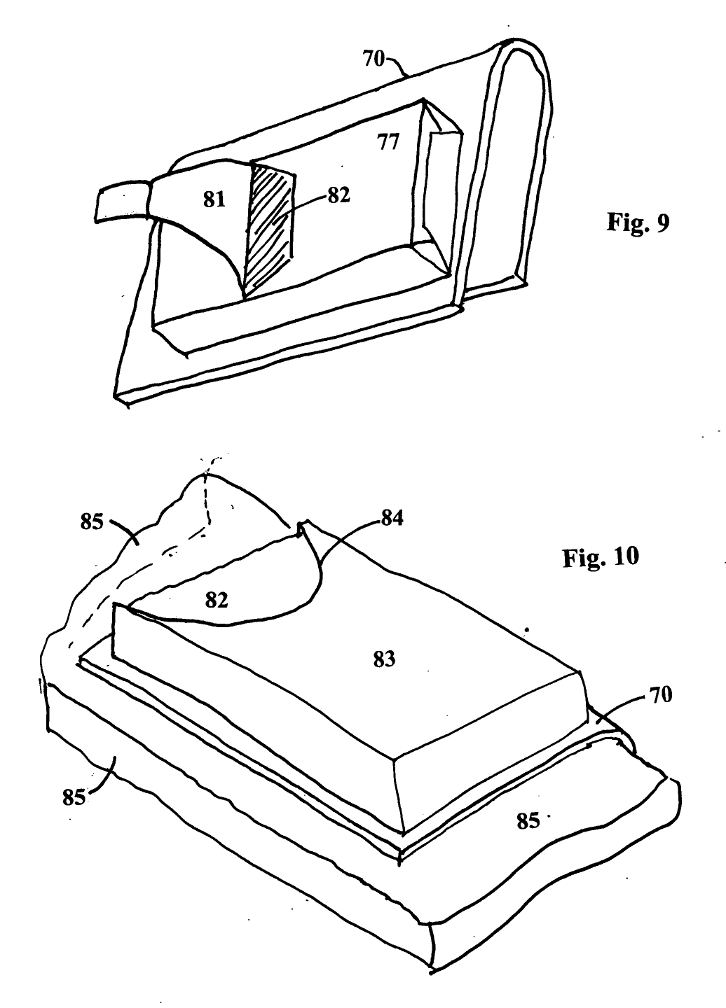

In FIG. 9, the tissue packet 77 of FIG. 8 is adhered to the U-clamp 70 of FIG. 7 Flap 81 has been opened on the tissue packet 77, exposing the first tissue 82. This may be readily removed by an automobile driver without being unduly diverted from the responsibilities of driving. When the packet is empty, it (the empty enclosure) may be removed and a new packet positioned on the U-clamp substantially as shown. It should again be noted that the tissue packet may be adhered to the U-clamp either by adhesive solely on the clamp or solely on the tissue packet or both.

FIG. 10 shows a variation of the invention wherein the tissue packet is not a flexible plastic film packet, but a stiff container 83 having an end opening 84 for retrieving tissues 82. The stiff container 83 may be made of plastic or cardboard, and has an adhesive area on its back similar to that shown for the flexible tissue packet in FIG. 8. FIG. 10 shows the U-clamp 70 installed on an automobile visor 85. The U-clamp and packet assembly of FIG. 9 may of course be installed on an automobile visor in the same manner. Again, the adhesive may be only on one of the U-clamp and the packet, or both.

1-20. (canceled)

21. A tissue holder and dispenser for clamping on an automobile visor comprising a U-shaped clamp having internal and external surfaces and a packet of tissues adhering by its back to said external surface of said U-shaped clamp.

22. Tissue holder and dispenser of claim 21 including an adhesive area on said external surface of said U-shaped clamp, said packet of tissues having an external tissue packet adhesive area, and wherein said external tissue packet adhesive area adheres to said clamp surface adhesive area on said clamp surface.

23. Tissue holder and dispenser of claim 22 wherein said tissue packet contains from 12 to 20 tissues.

24. Tissue holder and dispenser of claim 21 wherein said packet of tissues is from one and one-half inches to about three inches wide, about three and one-half to about six inches long, and about one-half inch to about one and one-half inches thick.

25. Tissue holder and dispenser of claim 24 wherein said packet of tissues comprises an enclosure of thin flexible plastic film.

26. Tissue holder and dispenser of claim 25 wherein said packet of tissues comprises from ten to twenty two-ply tissues

27. Tissue holder of claim 24 wherein said tissues have an area of from 36 to 121 square inches.

28. Tissue holder and dispenser of claim 21 wherein said packet of tissues comprises a stiff container having an opening side and a back side, and wherein said back side has an adhesive area on it.

29. Tissue holder and dispenser of claim 22 wherein said adhesive area on said tissue packet and said adhesive area on said clamp surface comprise Velcro.

30. An automobile including a visor and a tissue holder and dispenser of claim 21 clamped on said visor.

31. Method of making tissues available for dispensing in an automobile comprising (a) clamping a tissue holder and dispenser of claim 21 onto an automobile visor, (b) when said packet of tissues is empty, removing said empty packet of tissues, and (c) replacing said empty packet of tissues with another packet of tissues.

32. Method of making tissues available for dispensing in an automobile comprising (a) clamping a tissue holder and dispenser of claim 22 onto an automobile visor, (b) when said packet of tissues is empty, removing said empty packet of tissues, and (c) replacint said empty packet of tissues with another packet of tissues.

33. Method of claim 31 wherein said packets of tissues are from one and one-half inches to about three inches wide, about three and one-half to about six inches long, and about one-half inch to about one and one-half inches thick.

34. Method of claim 32 wherein said packets of tissues are from one and one-half inches to about three inches wide, about three and one-half to about six inches long, and about one-half inch to about one and one-half inches thick.

35. An automobile visor including a tissue holder and dispenser of claim 25 clamped thereon.

36. A visor bracket tissue holder and dispenser comprising an upper support, a central ledge, and a lower ledge, a first connecting member connecting said upper support from an edge thereof to said central ledge at a first edge of said central ledge, a second connecting member connecting said lower ledge from an edge thereof to a second edge of said central ledge, said second edge of said central ledge being opposite said first edge thereof, said upper support, first connecting member, central ledge, second connecting member, and lower ledge thereby forming a bracket having an S-shaped profile, said bracket further being resilient so as to be capable of clamping onto an automobile visor between said upper support and said central ledge and retaining a collapsible packet of tissues between said central ledge and said lower ledge throughout its tenure of use, said lower ledge also defining a central opening for tissues to be removed from said collapsible packet, and a packet of tissues between said central ledge and said lower ledge.

37. The visor bracket tissue holder and dispenser of claim 36 wherein said packet of tissues comprises an enclosure of thin flexible plastic film.

38. The visor bracket tissue holder of claim 36 wherein each of said tissues in said packet of tissues has an area from 36 square inches to 121 square inches.

39. An automobile visor including the visor bracket tissue holder of claim 36 clamped thereon.
